(19) United States
(12) Patent Application Publication
(10) Pub. No.: US 2022/0234810 A1
(43) Pub. Date: Jul. 28, 2022

(54) PLASTIC FILM AND PACKAGING USING THE PLASTIC FILM

(71) Applicant: Tecksom International Limited, Nassau (BS)

(72) Inventor: Luen Sing TANG, New Territories (HK)

(21) Appl. No.: 17/432,520

(22) PCT Filed: Feb. 25, 2020
(86) PCT No.: PCT/IB2020/051576

§ 371 Date: Aug. 20, 2021

(30) Foreign Application Priority Data
Feb. 28, 2019 (AU) 2019900656

(51) Int. Cl. B65D 81/34; B65D 77/20; B65D 65/42; B65D 81/32; B65D 75/58; B65D 33/25; B65D 33/01; B65D 75/20; B65D 77/22; B65D 65/40; C09J 7/40; C09J 7/30

(52) U.S. Cl. CPC B65D 81/3461; C09J 2433/00; B65D 65/42; B65D 81/3266; B65D 75/5805; B65D 33/2508; B65D 33/01; B65D 75/20; B65D 77/225; B65D 81/3453; B65D 65/40; C09J 7/401; C09J 7/30; C09J 2431/005; C09J 2423/005; C09J 2425/00; B65D 77/2024

(57) ABSTRACT

A multi ply plastic film to create a heat-sealed enclosure for food to be heated inside the enclosure save for a region of the heat-seal where a vent-opening can be established to allow gas and/or steam to escape the enclosure during heating of the food. The film has a primary panel to create the enclosure by heat sealing to itself or a separate panel or to a peripheral lip of a container There is also provided a release panel applied to said primary panel to be located intermediate of and to prevent the primary panel being heat-sealed to itself or peripheral lip at the peripheral heat-sealed region for the vent-opening to thereat be established.

### FIELD OF INVENTION

The present invention relates to plastic film and related packaging formed by or including the film.

### BACKGROUND

Plastic bags for retaining food items are well known. Plastic bags are commonly used for holding, transporting and storing products such as food. Plastic bags are versatile cheap and used widely in a vast array of applications including particularly for containing foods.

With busy lifestyles, there is a growing demand for convenience in preparing food that needs to be heated or cooked. Microwave bags such as those containing corn for making popcorn are well known. Such bags, when the content is heated, may burst open due to the increase in air pressure inside the bag. Such bursting may occur at a region of the bag where there is a weakness such as a perforation or a seal between panels of the bag that is thinner than at other parts.

However, the pressure within the bag is not easily controlled and a bursting of the bag may occur in random locations thereby spilling content undesirably. Prior art bags when placed in a microwave oven for example may hence be prone to rupturing or exploding in an unexpected way.

It is therefore an object of the present invention to provide a plastic film that may be used for the manufacturing of a plastic bag or packaging which overcomes the abovementioned disadvantages and/or which will at least provide the public with a useful choice.

It may also be an object of the present invention to provide packaging including a plastic film that helps to overcome the abovementioned disadvantages and/or which will at least provide the public with a useful choice.

### SUMMARY OF THE INVENTION

Accordingly, in a first aspect the present invention may broadly be said to be a multi ply plastic film to create a heat-sealed enclosure for food to be heated inside the enclosure save for a region of the heat-seal where a vent-opening can be established to allow gas and/or steam to escape the enclosure during heating of the food, the film comprising:

a primary panel to create the enclosure by heat sealing to itself or a separate panel or to a peripheral lip of a container,

a release panel applied to said primary panel to be located intermediate of and to prevent the primary panel being heat-sealed to the primary panel and the peripheral lip or the peripheral heat-sealed region for the vent-opening to thereat be established.

Preferably the multi ply plastic film is to heat-seal onto itself or onto a peripheral lip of a container to define the sealed enclosure.

Preferably the primary panel establishes the enclosure by heat sealing (preferably peripherally) to itself or a separate panel or to a peripheral lip of a container.

Preferable the release panel is applied to said primary panel to be located intermediate of the primary panel and the peripheral lip or the peripheral heat-sealed region of the panel to prevent the primary panel being heat-sealed thereat and for the vent-opening to thereat be established.

Preferably the release panel is adhered at one face side of and to said primary panel.

Preferably the release panel is located on a first face side of said primary panel.

Preferably the film is provided as roll-stock having an elongate direction and said release panel is a strip running continuously in the elongate direction.

Preferably the film is provided as roll-stock having an elongate direction and said primary panel is continuous of said film.

Preferably the film is provided as roll-stock having an elongate direction and said primary panel is continuous of said film and said release panel is a strip running continuously in the elongate direction applied at a first face side of said primary panel.

Preferably the film is provided as roll-stock having an elongate direction and said primary panel is continuous of said film and said release panel is a strip running continuously in the elongate direction applied on a first face side of said primary panel.

Preferably the release panel comprising a release ply or coating exposed as a first face side of the primary panel, that is not heat-sealable to the primary panel and/or the peripheral lip.

Preferably the coating is an adhesive.

Preferably the release panel comprising a release ply exposed as a first face side of the primary panel, that is not heat-sealable to thereat allow the vent opening to be established

Preferably the release ply is of a non heat-sealable material.

Preferably the release ply is of a non heat-sealable material and no coating is applied.

Preferably the non heat-sealable material is selected from one of:
a. EVA,
b. OPP
c. CPP,
d. RCPP and
e. MATT OPP.

Preferably the release panel comprises of a ply of material selected from one of:
a. PET,
b. Nylon,
c. OPP,
d. CPP,
and a coating exposed as a first face side of the primary panel comprised of an adhesive.

Preferably the release panel comprises of a ply of material selected from one of:
a. PET,
b. Nylon,
c. OPP,
d. CPP,
e. EVA,
f. RCPP,
g. PE
and a coating exposed as a first face side of the primary panel comprised of an adhesive.

Preferably the release panel comprises only of a ply of material selected from one of:
a. PET,
b. Nylon,
c. OPP,
d. CPP,
and a coating exposed as a first face side of the primary panel comprised of an adhesive.

Preferably the release panel comprises of a ply of MATT OPP presented at a first face side of the primary panel and coated with an adhesive.

Preferably the release panel also comprises a ply of PET.

Preferably intermediate of the ply of PET and of MATT OPP is a ply of PE.

Preferably the adhesive is a food grade adhesive.

Preferably the adhesive is SEIKADYNE.

Preferably when adhesive is used, the adhesive is presented as the exposed material of the release panel.

Preferably the plies of the release panel are adhered together.

Preferably the release panel and primary panel are adhered together.

Preferably the primary panel comprises a plurality of plies.

Preferably the primary panel comprises a plurality of plies that are each co-extensive each other.

Preferably the primary panel comprises a plurality of plies that are each co-extensive each other, other than the ply at the first face side of the primary panel that is to be heat-sealed which has a region absent at where said release panel is bedded.

Preferably the ply of the primary panel defining the first face of the primary panel is one selected from:
a. CPP,
b. EVA,
c. RCPP, and
d. PE.

Preferably the ply of the primary panel defining a second face thereof, opposite the first face, is one selected from:
a. OPP, and
b. PET.

Preferably the first face of said primary panel is heat-sealed onto itself at regions of the periphery of the enclosure formed by the film, save for where the release panel is provided.

Preferably the first face of said primary panel is not heat-sealed onto itself at regions of the periphery of the enclosure formed by the film where the periphery is formed by folded regions of the film.

Preferably the first face of said primary panel is heat-sealed to the peripheral lip of the container save for where the release panel is provided.

Preferably intermediate of the plies defining the first face and opposite face of the said primary panel there may be additional plies selected from at least one of:
a. Nylon
b. PET, and
c. PE.

Preferably the release panel is of a strip of between 5 mm and 50 mm wide.

In a further aspect the present invention may be said to be a film as herein described formed into a bag to define the enclosure and where the first face side of the film is heat sealed onto itself at the periphery of the enclosure.

In a further aspect the present invention may be said to be a film as herein described formed into a bag to define the enclosure and where the first face side of the film is heat sealed onto itself at the periphery of the enclosure and across the enclosure to divide the enclosure onto two compartments, save for a passage able to be formed between the two compartments by the provision of the release panel at the divide.

In a further aspect the present invention may be said to be a bag formed by a film as herein before described wherein the first compartment contains a liquid and the second compartment contains food to be heated including by being exposed to said liquid.

Preferably the release panel is adapted to create a passage between the two compartments.

Preferably at at least one perimeter region of the bag at there the first face of the first panel is heat-sealed onto itself, said release panel is provided to allow a passage for fluid between the enclosure and the outside of the bag.

Preferably the adhesive applied to the release panel, where provided, results in a releasable sealing interface of the release panel with the first face of the primary panel.

Preferably the adhesive of the release panel, where provided, results in a releasable and resealable sealing interface of the release panel with the first face of the primary panel.

Preferably the bag comprises said film as herein described defining a first panel of said bag and a second panel heat-sealed to the first panel at its perimeter to define an enclosure the first panel presenting the release panel as a strip that extends across the bag and between two opposed sides of the bag, the two opposed sides heat sealed together save for at where said strip is provided.

Preferably a tear notch is provided at one or each said opposed sides of the bag at where the bag can be torn by a user.

In a further aspect the present invention may be said to be a container comprising a body defining at least one containment region bounded upwardly thereof by a perimeter lip of the body, the film as herein described heat sealed to the perimeter lip to cover the containment region and wherein the release panel is positioned at the lip to prevent heat-sealing of the primary panel to the lip so that a passage is or can be formed between the containment region and the outside of the container for the passage of fluid(s).

Preferably there is an intermediate lip expending between two separated regions of the perimeter lip that creates two separate compartments of said containment region and where said film is heat sealed along the intermediate lip and the release panel is located at a region of the intermediate lip to prevent the primary panel heat-sealing thereat to the intermediate lip.

In a further aspect the present invention may be said to be a bag able to be heated for making a hot beverage comprising the film as herein described formed into a bag comprising a first compartment and a second compartment separated from each other by a heat seal across the film and peripherally, bonding the primary panel to itself save for a vent opening able to be established at the release panel that extends at least across the heat-seal between the first and second compartments to allow said vent opening to be established between the first and second compartments, wherein the first compartment contains water and the second compartment contains an ingredient to mix with said water to at least in part dissolve in said water.

Preferably the ply of the primary panel at the first face side comprises of two panels separated by said release panel located in a contiguous manner in between the two panels.

Preferably the ply of the primary panel at the first face side is discontinuous and at the discontinuity there is provided the release panel.

Preferably the release panel is adhered to the ply of the primary panel adjacent the ply of the primary panel at the first face side.

Preferably the release panel is the same thickness and the ply of the primary panel at the first face side.

In a further aspect the present invention may be said to be a bag comprising the film as herein before described formed into a bag by having been folded and peripherally heat sealed onto itself or with like heat seal compatible film to define an enclosure with a first compartment and a second compartment separated from each other by a heat seal across the bag bonding the primary panel of the film of claim 1 to itself or a like heat seal compatible film such that a vent opening is able to be established at the release panel that extends at least across the heat-seal provided between the first and second compartments between the first and second compartments.

Preferably the release panel extends across a peripheral heat seal of at least one of said first and second compartments.

Preferably the release panel extends across a peripheral heat seal of said first compartment only so that content of said second compartment escapes the second compartment via the vent into the first compartment.

Preferably the first compartment has a release panel at a peripheral heat seal region.

Preferably the first compartment contains water and the second compartment contains an ingredient to mix with said water to at least in part dissolve in said water.

In a further aspect the present invention may be said to be a bag comprising the film as herein described formed into a bag by having been folded and peripherally heat sealed onto itself or with like heat seal compatible film to define an enclosure with a first compartment and a second compartment separated from each other by a heat seal across the bag bonding the primary panel of the film of claim 1 to itself or a like heat seal compatible film such that a vent opening is able to be established at the release panel that extends at least across the heat-seal provided between the first and second compartments between the first and second compartments.

Preferably the release panel extends across a peripheral heat seal of at least one of said first and second compartments.

Preferably the release panel extends across a peripheral heat seal of said first compartment only so that at least some content of said second compartment escapes the second compartment via the vent into the first compartment.

Preferably the first compartment has a release panel at a peripheral heat seal region.

Preferably the first compartment contains water and the second compartment contains an ingredient to mix with said water to at least in part dissolve in said water.

Preferably a zip lock male and female strip are carried by said primary panel.

Preferably said zip lock male and female strip extend parallel the elongate direction of the release panel.

Preferably said zip lock male and female strip extend transverse the elongate direction of the release panel.

In a further aspect the present invention may be said to be a bag comprising
a. the film as herein described formed into a bag by having been folded and peripherally heat sealed onto itself or with like heat seal compatible film to define an enclosure,
b. a zip lock extending across the enclosure to divide the enclosure into a first compartment and a second compartment, the first and second compartments able to be separated by said zip lock yet able to be connected upon an opening of the zip lock.

Preferably the release panel extends across a part of the peripheral seal between at least one of said first and second compartments and the outside the bag such that a vent opening can be established thereat to allow content of said at least one of said first and second compartments to escape from said bag.

Preferably the release panel extends across a part of the peripheral seal between one of said first and second compartments and the outside the bag such that a vent opening can be established thereat to allow content of said first or second compartments to escape from said bag.

Preferably the release panel extends across a peripheral heat seal of at least one of said first and second compartments.

Preferably the release panel extends across a peripheral heat seal of said first compartment only so that at least some content of said second compartment escapes the second compartment via opening between the first and second compartments able to be created by said zip lock, into the first compartment.

Preferably the first compartment has a release panel at a peripheral heat seal region.

Preferably the first compartment contains water and the second compartment contains an ingredient to mix with said water to at least in part dissolve in said water.

Preferably the second compartment contains water and the first compartment contains an ingredient to mix with said water to at least in part dissolve in said water.

Preferably the first compartment and second compartment are of a capacity of similar size.

Preferably the first compartment is no less than 5% of the capacity of the second compartment.

Preferably the first compartment is no less than 10% of the capacity of the second compartment.

Preferably the first compartment is no less than 20% of the capacity of the second compartment.

Preferably the first compartment is no less than 50% of the capacity of the second compartment.

Preferably wherein the second compartment is no less than 5% of the capacity of the first compartment.

Preferably the second compartment is no less than 10% of the capacity of the first compartment.

Preferably the second compartment is no less than 20% of the capacity of the first compartment.

Preferably rein the second compartment is no less than 50% of the capacity of the first compartment.

Preferably the first compartment and second compartment both contain edible ingredients.

In a further aspect the present invention may be said to be a bag comprising, a front and back panel connected to each other to form an enclosure,

a zip lock extending across the enclosure dividing the enclosure into a first compartment and a second compartment, the first and second compartments able to be separated by said zip lock yet able to be connected upon an opening of the zip lock.

Preferably the front panel and/or the back panel comprises of the film as herein described.

Preferably the film has been folded and peripherally heat sealed onto itself or with like heat seal compatible film to define an enclosure.

Preferably the release panel extends across a part of the peripheral seal between at least one of said first and second compartments and the outside of the bag such that a vent opening can be established thereat to allow content of said at least one of said first and second compartments to escape from said bag.

Preferably the release panel extends across a part of the peripheral seal between one of said first and second compartments and the outside the bag such that a vent opening can be established thereat to allow content of said first or second compartments to escape from said bag.

Preferably the release panel extends across a peripheral heat seal of at least one of said first and second compartments.

Preferably the release panel extends across a peripheral heat seal of said first compartment only so that at least some content of said second compartment escapes the second compartment via opening between the first and second compartments able to be created by said zip lock, into the first compartment.

Preferably the first compartment has a release panel at a peripheral heat seal region.

Preferably the first compartment contains water and the second compartment contains an ingredient to mix with said water to at least in part dissolve in said water.

Preferably the second compartment contains water and the first compartment contains an ingredient to mix with said water to at least in part dissolve in said water.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Reference to the invention will now be made with reference to the accompanying drawings in which;

FIG. 1 is a perspective view of the film of one example of the present invention provided as roll stock,

FIG. 2 shows an end view in direction A of FIG. 1 of the film of an example of the present invention,

FIG. 3A shows the film of FIG. 1 having been folded onto itself and heat sealed at two perimeter regions,

FIG. 3B shows a variation to FIG. 3A where the bag is presented pre-filling of content with a mouth opening 300 at the opposite edge of the bag to the fold 8A,

FIG. 4 shows the heat seal at the end region B of the bag of FIG. 3A,

FIG. 5-8 are sectional views of examples of a plastic film according to the present invention,

FIG. 8 A-D are sectional views of examples of a plastic film according to the present invention,

FIG. 8E shows a bag with a zip lock strip incorporated,

FIG. 8F shows a bag of FIG. 8E in cross section at section AA,

FIG. 8G shows a bag of FIG. 8E in cross section at section AA having its zip lock burst open,

FIG. 8H shows the bag of FIG. 8E in a self standing format,

FIGS. 8I and J are sectional views of examples of a plastic film according to the present invention

FIG. 9 is a perspective view of a bag peripherally heat sealed using the film of the present invention,

FIG. 10 shows an alternative configuration of a bag wherein two compartments are provided for the retaining of food in a separated condition yet allowing for the food or ingredients to transfer from one compartment to another within the containment region of the bag to facilitate mixing of ingredients,

FIG. 11 is a cross sectional view through a container having a film of the present invention applied thereto,

FIG. 12 is a plan view of the container of FIG. 11,

FIG. 13A is a plan view of an alternative view of a container having an intermediate wall with lip to which the film of the present invention is also able to be sealed to.

FIG. 13B is a perspective view of FIG. 13A but with no film present.

### DETAILED DESCRIPTION OF THE PRESENT INVENTION

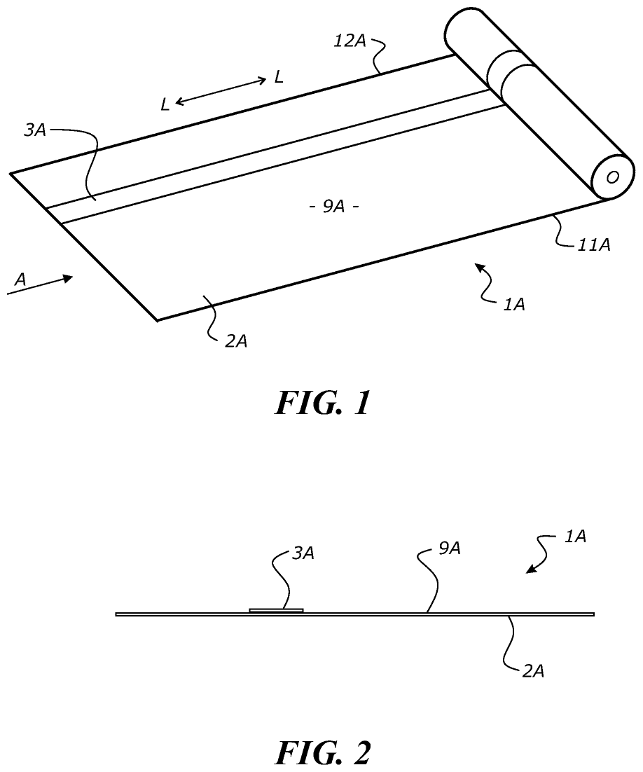

With reference to FIG. 1 there is shown a film as an example of the present invention. The film 1A comprises of a primary panel 2A and a release panel 3A. The primary panel 2A may comprise of a plurality of plies of plastic and the release panel 3A may also comprise a plurality of plies that will herein after be described.

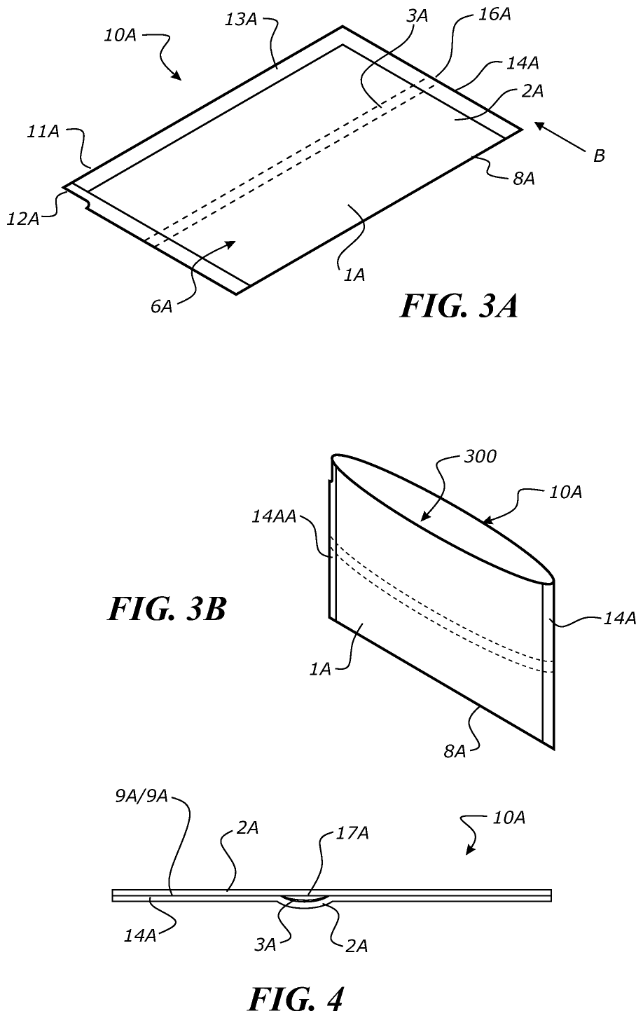

The plastic film may be formed into a plastic bag that has a containment region such as the region 6A as seen in FIG. 3A and within which food or ingredients may be located.

The bag may be formed by the film by being preferably sealed, such as by way of heat sealing, at its perimeters or perimeter and may also be formed by a fold such as the fold 8A of the primary panel 2A onto itself.

Provided on the first face side 9A of the primary panel 1A is the release panel 3A. The first face side 9A of the primary panel is preferably of a ply of plastic that is heat sealable.

The primary panel 1A is preferably provided in an elongate form so as to be able to be presented as roll stock for the use in the forming, filling and sealing of bags using the film 1A of the present invention. In the preferred form the release panel 3A is in the form of a strip that is continuous with the elongate direction LL of such primary panel 2A.

The bag 10A may be formed from the film 1A by folding the primary panel 2A to create the fold 8A and heat sealing the primary panel onto itself along elongate edges 11A and 12A creating a heat seal 13A along and bonding the edges 11A and 12A and a transverse heat seal 14A.

The transverse heat seal 14A may be provided to seal across the folded film and an additional transverse heat seal (not shown) at the opposite end to the transverse heat seal at 14A may then seal the bag closed to provide an enclosed containment region 6A of a bag and within which food ingredients are or are able to be placed.

The release panel 3A, being preferably of a continuous strip also becomes located at the transverse heat seal 14A during the bag formation process. It extends across the heat seal and this is where a vent region 16A of the bag is able to be created. This vent region is more clearly shown with reference to FIG. 4.

Appropriate selection of material or materials of the release panel 3A and/or the ply of the primary panel 2A that defines the first face side 9A will ensure that the transverse heat seal 14A is established across the width of the bag save for at the release panel 3A. The release panel 3A and the primary panel 2A are prevented from heat sealing and a vent opening 17A is able to be established thereat to allow for at least some contents of the containment region 6A to escape the bag via the vent opening 17A.

FIG. 3B shows a variation to FIG. 3A where the bag is presented pre-filling of content with a mouth opening 300 at the opposite edge of the bag to the fold 8A.

The bag may be manufactured this way and shipped to companies that may load content in the bag at a different location. The filing and final sealing of the bag by such companies is completed by a heat-sealing the bag across the mouth opening 300. Such subsequent sealing a sealing of the regions of the bag that do not include the release panel. The release panel regions for the bag have already been sealed prior. There is an advantage is doing so, in under to ensure that the seals of the bag containing the release panels are established in a desirable condition and this may be dependent on accurate setting (eg temperature and dwell time) of the sealing process.

In some forms the release panel may not be of a strip form. Instead it may be provided as a patch located only across a heat seal of the bag.

The bag 10A may contain food such as prawns or meat to be heated. The contents of the bag may become frozen and may subsequently be heated.

The bag 10A may contain, for example, water to be heated in a microwave oven. The bag may also contain other ingredients that may be heated by, in or with the water or steam also contained in the bag, generated during the heating of the contents of the bag.

Food may be cooked inside the bag.

During heating, expansion of gasses/vapours in the containment region 6A is able to be accommodated to a certain extent by the bag's flexible nature. However a venting of fluids from the containment region can help prevent the bag from bursting open and this venting is facilitated by the vent opening 17A.

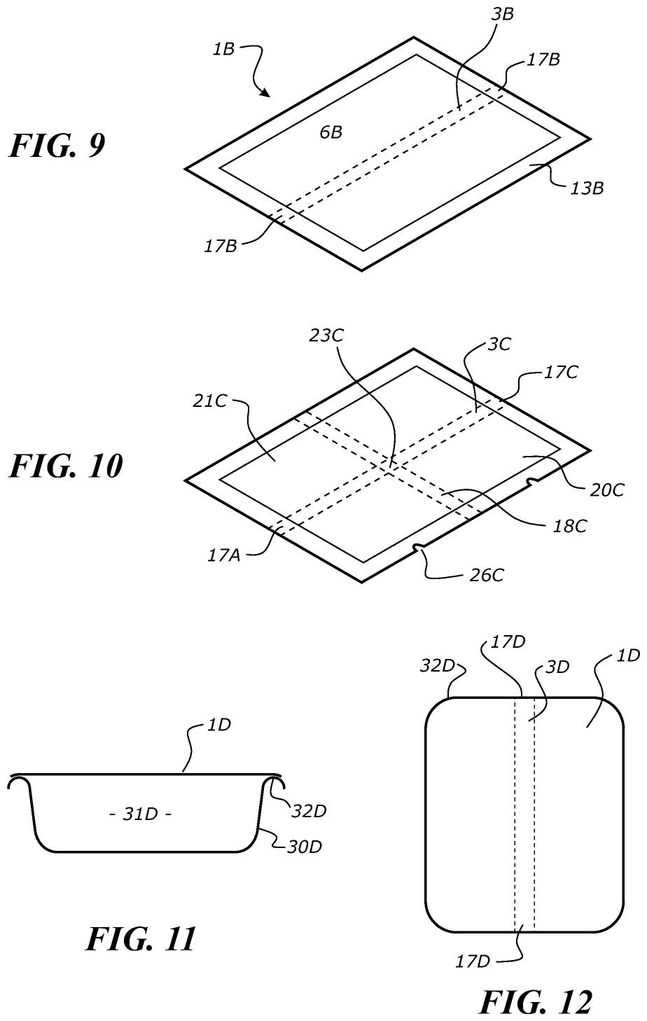

As can be seen in FIG. 9, two vent opening regions 17B may be provided at opposite ends of the bag by virtue of the release panel 3B, being in the form of a strip, extending across the bag as shown. The bag 1B of FIG. 9 may be formed from the film of FIG. 1. Alternatively the bag of FIG. 9 may have the primary panel with release panel defining one side of the bag and may have the other side of the bag defined by a different panel, that is heat seal compatible with the primary panel.

The heat sealed region 13B about the perimeter of the bag remains intact during a heating of the contents of the bag and expansion of the bag is at least in part accommodated but any further expansion is prevented virtue of a pressure release via the vents 17B that allow for fluids to escape the containment region.

FIG. 10 shows a variation of the bag of the present invention wherein an intermediate heat seal 18C is provided in addition to perimeter heat seal(s). The bag of FIG. 10 still includes peripheral vents 17C but the intermediate heat seal 18C creates two compartments 20C and 21C of the containment region separated by the heat seal 18C. The heat seal 18C bonds the two face panels of the bag together across the bag to define the two compartments 20C and 21C. The release panel extends across the heat seal 18C. A first compartment 20C may include water and the second compartment 21C may include tea leaves. Upon a heating of the bag and its content, such as by microwave heating, the water will start to warm up and potentially boil and air in the bag will expand. This will result in increasing pressure in the compartment 20C. The provision of the release panel 3C across the intermediate heat seal 18C will result in a vent opening 23C being established to thereby allow for fluids to pass from the compartment 220C into the compartment 21A. This may result in the tea leaves from becoming immersed in the migrated hot or boiling water for the purposes of creating a drinkable tea. As will herein after be described, the release panel may be configured to ensure a seal is established thereby with the adjacent ply until (a) the internal pressure of the bag reaches a point where the seal is released and the vent opening is established and/or (b) a user initiates the opening of the vent opening.

More than two compartments are also envisaged. For example 3 or 4 or 5 compartments may be provided for.

A tear notch 26A may be provided at a peripheral region of the bag to allow for a user to initiate a tear of the bag at that location to allow for access to be gained to the containment region 21A to dispense the tea from the bag. It will be appreciated that other ingredients may be provided in the bag, separated into compartments for user initiated transfer between compartments.

Other examples of ingredients include dried noodles and water or coffee and water. Some of the ingredients may themselves be packaged and located inside a compartment. For example the tea may be contained in a tea bag contained in a compartment of the bag.

Shown in FIG. 11 is a container 30D includes a containment region 31D within which food can be located. The container may be of a thermoformed plastic for example. The film 1D of the present invention is able to heat seal to the periphery 32D of the container. The periphery may be defined by peripheral lip that is continuous about or at the periphery of the container. The release panel 3D is provided to locate at the lip and across the heat seal at the lip. This means that a vent region 17D can be established to ensure expanding fluids in the compartment 31D can escape.

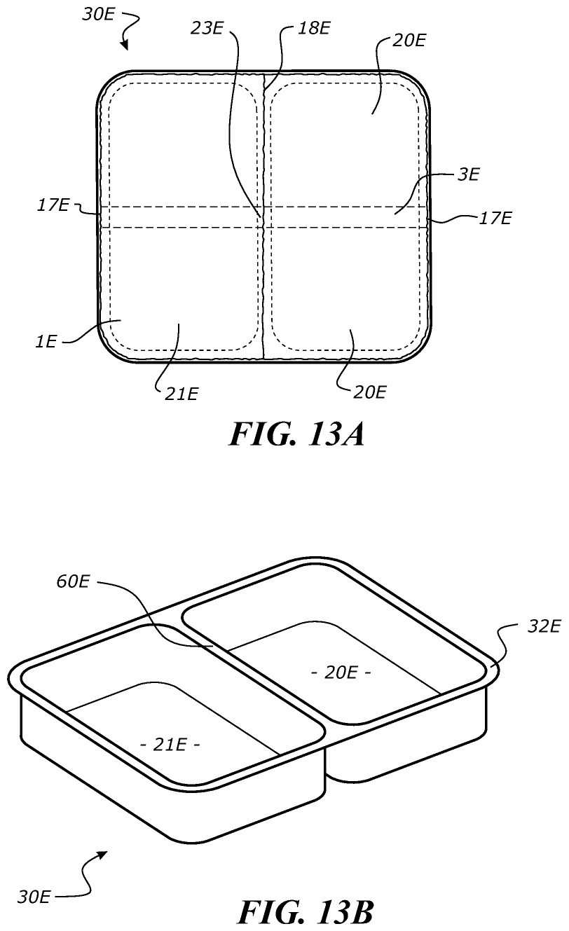

FIGS. 13A and B show a container 30E having an intermediate wall 60E across the containment region of the container to define two compartments 20E and 21 E. A heat seal 18E of the primary panel of the film 1E may be established along the intermediate wall 60E save for at where the release panel 3E extends across the wall. A vent opening may hence be established thereat to allow for fluids to transfer from one compartment to the other. Fluids may also vent out via the vent openings at the periphery of the container at 17E on each side.

In one modification only one peripheral vent opening 17E is provided so that fluids expanding in one compartment of the container flow into the other compartment via the vent opening 23E before expanding out through the one peripheral vent opening 17E. This will encourage for example steam or water vapour to transfer from one compartment to the other and then out of the container. Alternatively the peripheral vents 17E may require more pressure in a compartment in order to form compared to the internal vent 23E. The same may apply for the vents of the bag of FIG. 10.

The container lip is preferably of a material that is heat seal compatible with the primary panel, in particular the first face 9E of the primary panel which makes contact with the lip and is able to be heat sealed to the lip of the container.

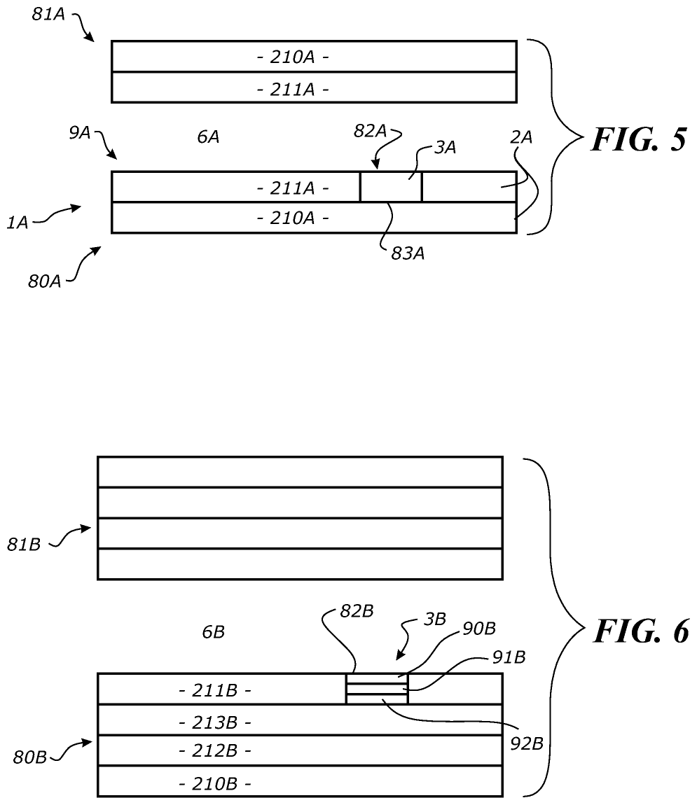

Examples of the film and its construction will now be given with reference to FIGS. 5-8.

With reference to FIG. 5 there are shown one embodiment of a film of the present invention.

This film may be folded over, such as shown, for example, in FIG. 3A and in FIG. 5 is shown in cross section the two panel sections 80A/81A of the film so folded (the fold not shown), one that includes the release panel and the other without the release panel.

The film 1A can be formed, for example, into two overlying panel sections 80A/81A to define an inside region 6A of the bag.

With reference to the bottom panel 80A the film 1A comprises of the primary panel and the release panel 3A. The primary panel comprises of an outside ply 210A and an inside ply 211A. The inside ply 211A defines the inner surface 9A of the bag. The outside ply 210A is preferably of a material selected from OPP or PET.

The inside ply 211A is preferably of PE. These two plies define the primary panel 2A and are preferably bonded together by glue. They are not heat sealed together although the panels 80A and 81A do become heat sealed together at their periphery to form a bag.

It can be seen that the release panel 3A is bedded into the inner ply 211A. The release panel 3A is preferably of the same thickness of the inner ply 211A. The ply 211A is hence preferably continuous over the entire surface area of the panel 80A.

A strip of the release panel 3A preferably extends along the film 1A and it resides in a recess or gap in the inner ply 211A as seen in FIG. 5.

The material of the release panel 3A is preferably one selected from (a) PET, or (b) nylon, or (c) OPP, or (d) CPP or (e) PE and preferably has a layer of adhesive 82A applied to the exposed surface of the release panel 3A.

The adhesive is preferably an adhesive known as SEIKADYNE. It may be a gravure polymer. It may be able to perform as a hot pressing adhesive. It may comprise of 25-30% resin, 10-20% Toluene, 5-10% alcohol and 1-5% pigment

The adhesive is preferably added to the surface of the release panel 3A by ink jet printing. It may be applied to the entire exposed surface of the release panel 3A or may be spot applied. It may be applied only at where the primary panel is heat sealed.

The food grade adhesive may be added to the surface of a release panel as described in some embodiments herein. The adhesive helps prevents the release panel from being heat-sealed thereat. The adhesive acts like oil helping to prevent heat-sealing. Therefore, even if the outer layer of the release panel is made of a heat-sealable material, the adhesive helps prevent heat-sealing thereat.

A strip of the inner ply 211A (the PE layer) may be removed to make room for the release panel that is then laid it the channel and becomes affixed to the inwardly facing surface of the outer ply 210A at region 83A. This is preferably achieved by the use of an adhesive only.

In the preferred form the release panel is not thicker than the inner ply in order that there are not bumps on the inner surface of the bag.

Preferably, the release panel has the same or slightly lower thickness than the inner ply.

Preferably the release panel may instead be slightly greater in thickness than the inner. The release panel and/or the inner ply may be sufficient soft when heat and pressure is applied to them for them to be compliant with each other.

When the relevant perimeter of the bag is heat sealed (ie, the inner plies of PE are welded together), the bag becomes heat sealed save for at where the adhesive on the release panel is applied which prevents the release panel from being heat sealed to the opposite layer of PE. The adhesive acts like a release agent to prevent such heat sealing from occurring thereat.

In this embodiment the adhesive is a food graded adhesive and the bag can be used where there is no vacuum formed inside the bag.

An alternative embodiment of a film of the present invention will now be described with reference to FIG. 6.

In FIG. 6 there is shown a multi ply construction of the film of or for forming a bag. Again, where there are two panels 81B and 80B defining a bag interior 6B.

Panel 80B includes the release panel 3B and the construction of the film may be as follows. Ply 210B may define the outermost ply of the film and may comprise of PET. The PET layer can add resistance against stretching of the film. The next layer 212B may be nylon. The nylon can act as a good shield against loss of steam or gas from the containment region and can also provide resistance against stretching. The next ply 213B may be made from PE. PE can act like cementitious material filling up holes and gaps that may result in formation and/or heat sealing of the bag. The inner most ply 211B is preferably of RCPP. These four layers of the film define the primary panel and may be bonded together by adhesive. They are not heat sealed together other than at the perimeter regions where heat sealing may bond some of these plies together even further and certainly the panels 80B and 81B are so bonded together. The release panel may be of a multi ply construction. The outer most ply 90B is preferably of MATT OPP. The use of MATT OPP is preferable because this can help with the gradual release of steam or gas from inside the bag rather than an erratic or popping style opening being created. To help facilitate this the outer ply may also include a layer 82B of an adhesive such as SEIKADYNE. This adhesive is a food graded adhesive. The second ply of the release panel 91B is preferably PE. The inner most ply 92B of the release panel is preferably PET. The use of PET can make the release panel more firm for easier handling during manufacturing and affixing of the panel to the ply 213B. The firmness is also suitable in forming and maintaining a vacuum in the bag.

The three plies of the release panel are preferably bonded together by glue but are not heat sealed together. Again, an exterior adhesive may be applied by ink jet printing or other methods to the release panel.

In the formation of the film a strip of the bags inner ply 211B may be first removed and then replaced by the release panel.

The release panel is affixed to the bags PE ply 213B by adhesive. Again, in a preferred form the release panel should be of a thickness so as to provide a smooth inner surface of the film of the bag. The exterior adhesive is preferably a food graded adhesive and is added to the release panel and in this construction of the film, and once formed into a bag, a vacuum is able to be formed inside the bag.

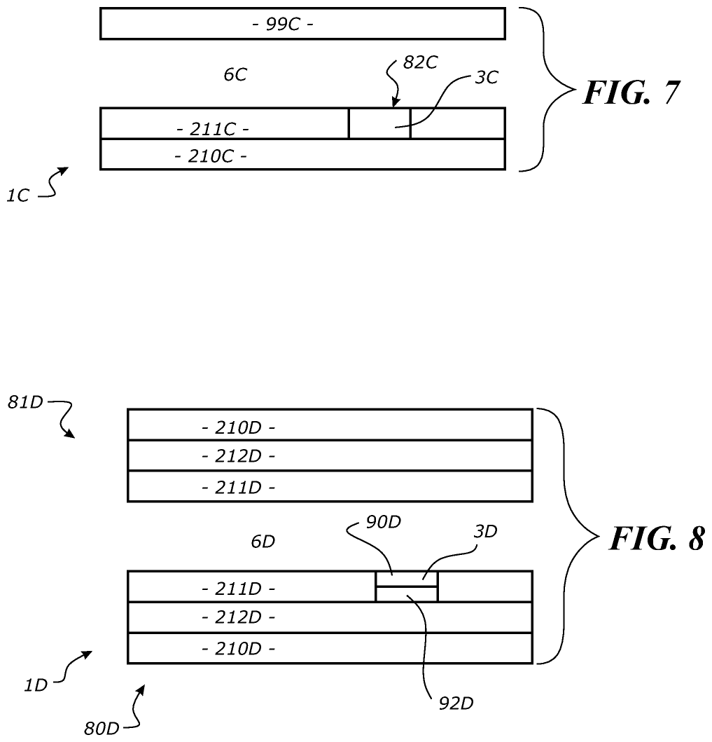

A further example of the film of the present invention is shown with reference to FIG. 7 where the film 1C is able to be applied to a box or container 99C. The box or container may be made from PP as an example. The film 1C is able to be heat sealed to the container. An inside containment region 6C may be defined. The film 1C for engagement to the container may comprise a primary panel comprised of an exterior ply 210C made from PET and an interior ply 211C may be made from EVA. The release panel 3C is preferably made from either (a) OPP or (b) CPP. The release panel may have adhesive 82C applied to all or parts of its exposed surface and preferably applied at regions of the exposed surface of the release panel at where heat sealing of the film occurs to the container. The adhesive may then be SEIKADYNE as herein before described. The adhesive is preferably food grade and the use of the food grade adhesive helps prevent the release panel from being heat sealed to the PP material of the container. The adhesive acts like a release agent to prevent heat sealing occurring. The release panel is preferably located in a removed strip of the EVA ply 211C which is then replaced by the release panel. The release panel is preferably affixed to the exterior ply 210C by adhesive.

Again, in the preferred form the release panel is preferably of the same thickness of the inner ply 211C so as to define a smooth inner surface of the film 1C. It is possible to add or remove layers to the exterior PET layer for extra strength of the film.

The use of the PET ply 210C is because it is a harder material than OPP or EVA and so it is better for manufacturing of the film. PET may be better because PET can withstand high temperature and it can work very well during packing of food into the bag by the user of the bag. This embodiment, the bag, the food grade adhesive is added to the release panel and preferably no vacuum is formed inside of the compartments of the box.

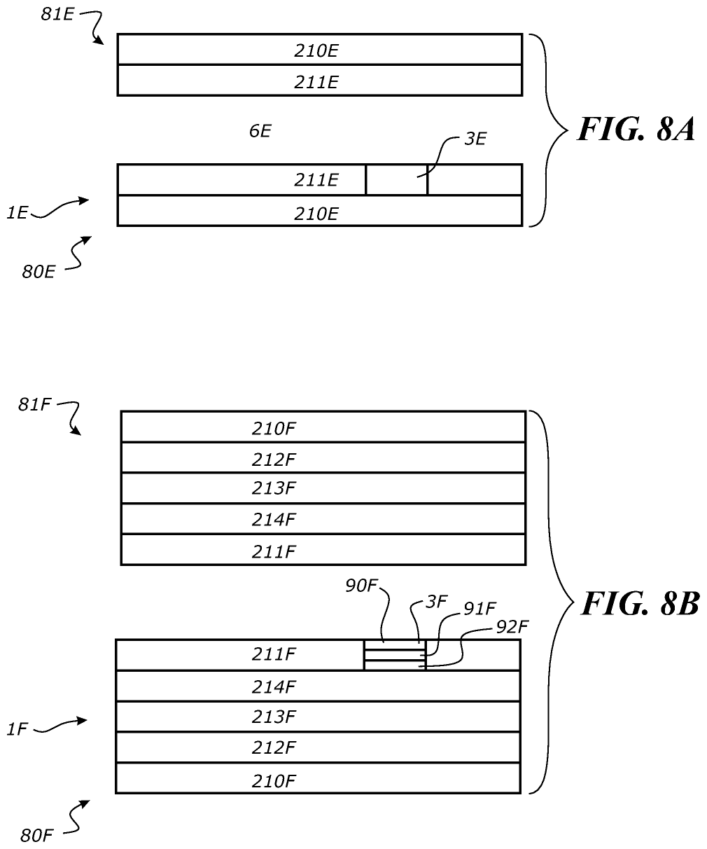

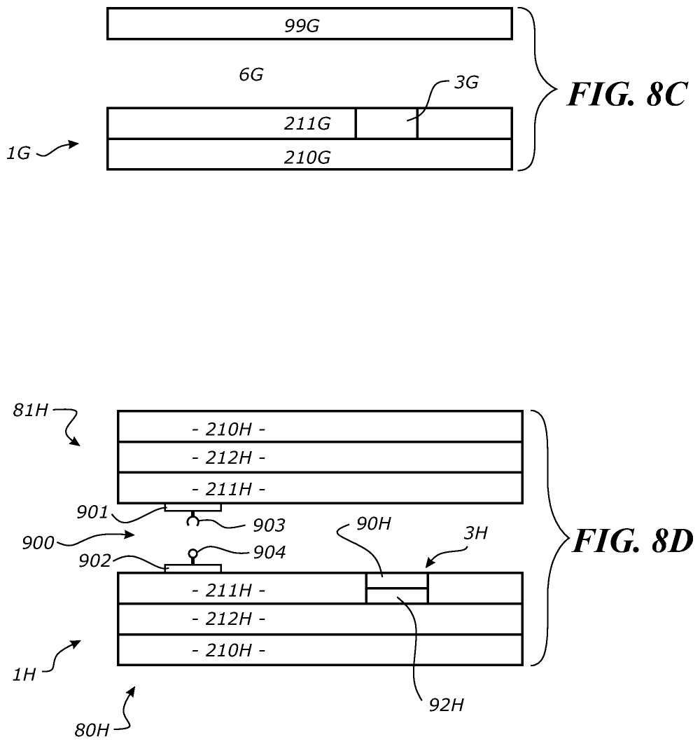

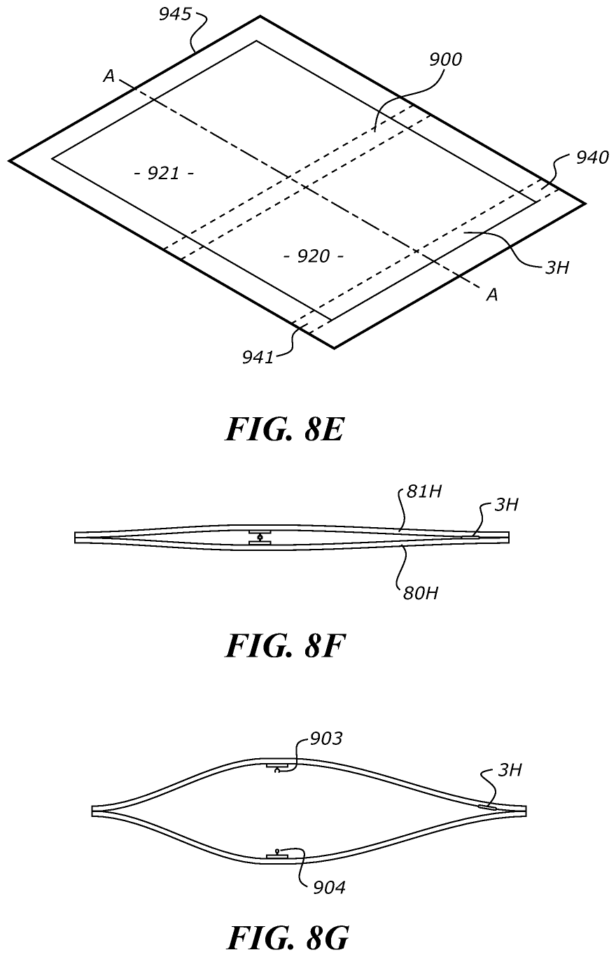

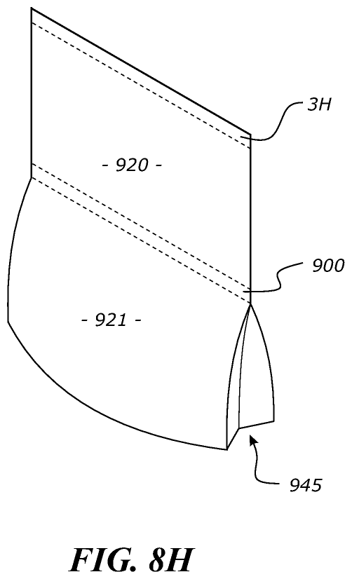

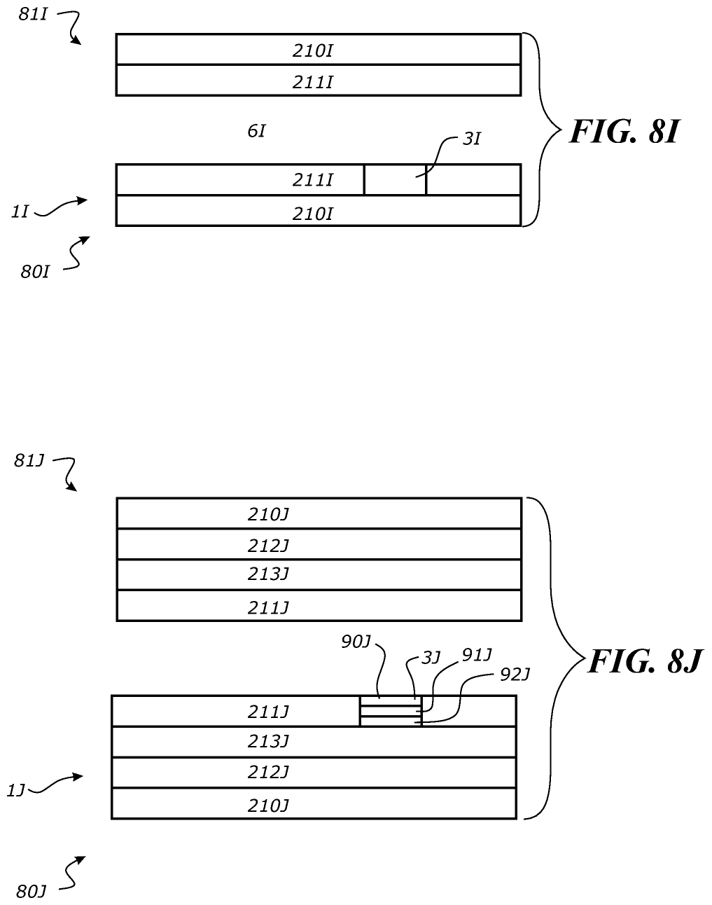

A further variation of the film of the present invention will now be described with reference to FIG. 8 in which the film 1D may again be used to define a first panel 80D and a second panel 81D. Again, the film 1D may be formed to define an interior 6D of the bag. In this embodiment the bag may be used for mixing tea bags with water as has herein been described. The film 1D has a primary panel that preferably comprises of an exterior ply 210D preferably made from PET. A second ply 212D may be provided inside of the exterior ply 210D and this ply may also be made of PET. The interior ply 211D is preferably made of PE or CPP. The three layers of the primary panel are preferably bonded by glue together. The bag in this instance that may be formed may include water and tea bags and may be heated in a microwave. Given that the boiling temperature of water in atmospheric pressure is 100° C. there is no high temperature requirement. No vacuum needs to be formed inside the bag and using PE or CPP is sufficient. The release panel 3D preferably comprises of two plies of material 90D and 92D. The ply 90D provides an exposed surface that may in part or in total be covered by a food grade adhesive such as SEIKADYNE as has herein before been described. The ply 90D is preferably of MATT OPP and the ply 92D is preferably of PET.

When the relevant perimeter of the bag is heat sealed (ie, the PE/CPP layer is heat sealed to the opposite PE/CPP layer the food graded adhesive prevents the tape from being heat sealed to the bags opposite PE/CPP layer). The adhesive acts as a release agent to help prevent such heat sealing. The three plies 210D-211D are preferably bonded by adhesive together.

A further embodiment will now be described with reference to FIG. 8A in which the film 1E is shown. The film 1E may be formed to define two panels 80E and 81E to form a bag preferably of a kind where vacuum is formed inside the bag. The film 1E comprises a primary panel that may comprise of an exterior ply 210E preferably of PET or OPP and an interior ply 211E is provided preferably of EVA. Bedded in EVA layer is the release panel 3E. The release panel like is hereinbefore described, is preferably bonded to the ply adjacent the inner ply 211E, in this case the ply 210E. A strip of the films EVA layer is first removed and which may then be replaced by a strip of the release panel 3E. The release panel is preferably affixed to the bags PET or OPP ply 210E by adhesive only. Again, the thickness of the release panel 3E is preferably the same as the inner ply 211E to ensure a smooth inner surface of the bag is provided. The embodiment shown in FIG. 8A is very similar to the embodiment of FIG. 5 except that (a) the PE layer of the bag is replaced by an EVA layer and (b) the release panel is preferably made of OPP or CPP or RCPP or MATT OPP instead but without the provision of an adhesive applied to the exposed surface of the release panel 3E. The release panel is preferably made of OPP, CPP, RCPP or MATT OPP. The relevant perimeter of the bag can be heat sealed (ie, the EVA layer is heat sealed to the opposite EVA layer and this is enabled by those layers being of the same material). However, the material of the release panel is of a different material from the EVA layer, the release panel is hence prevented from being heat sealed to the bags opposite EVA layer. Instead a sticky relationship is established between the release panel 3E and the opposite interior ply 211E at the perimeter heat seal. In other words, the EVA layer cannot be heat sealed to the release panel because of the characteristics of the EVA and because of the material of the release panel not being EVA. These materials are typically not heat seal compatible, and as a result no adhesive such as of a kind as hereinbefore described needs to be applied. As a result of material costs and manufacturing time can be reduced.

A further embodiment of the invention will now be described with reference FIG. 8B where the film 1F is provided and may be formed to define two panels 80F and 81F of a bag preferably of a kind where no vacuum is formed inside. The film 1F may comprise of a primary panel of an exterior ply 210F preferably of a PET material. The PET material can add resistance against stretching. A second ply 212F may be provided and is of nylon. A subsequent ply 213F may be provided and this may be of PE. PE can act like a cementitious material filling up holes and gaps that may established or exist in the formation of the film and/or during heat sealing. A further ply 214F may be provided of RCPP. This is optional. An interior ply 211F may be provided and made of EVA. A release panel 3F preferably comprises of an exterior ply 90F preferably made of OPP or CPP or RCPP or MATT OPP. An innermost ply 92F may be provided of PET. An intermediate ply 91F may be provided of PE.

This embodiment is similar to the embodiment shown in FIG. 6 except that (a) an EVA layer is added on top of the RCPP layer of the bag and (b) the exposed layer of the release panel can be of OPP or CPP or RCPP or MATT OPP. In this construction no adhesive needs to be applied to the exposed surface of the release panel and the mechanism of operation is similar to that or the same as that of the embodiment shown in FIG. 8A.

A further embodiment of the present invention will now be described with reference to FIG. 8C in which the film 1G is shown for engagement as the container 99G to provide an enclosure or compartment 6G. The film 1G preferably comprises of an exterior ply 210G and is preferably made of PET. The film 1G may also comprise of an interior ply 211G that may be of EVA. The film 1G also comprises of a release panel 3G that is preferably set into the interior ply 211G in a similar way as has been described before. The release panel 3G is preferably of EVA. In this embodiment no adhesive is required to be added.

This embodiment is similar to the embodiment shown in FIG. 7 except that (a) the release panel is made of EVA instead and so no food grade adhesive is required, and (b) the adherence strength of the EVA layer to the PP box is stronger than (almost double) the adherence strength of the EVA release panel 3G.

The adherence strength of the EVA material for the release panel is weaker than the adherence of a strength of the EVA material of the interior ply 211G.

When a pressure is built up to a certain level within the compartment of the container when heating up food, for example, in a microwave oven, a vent will be opened but the EVA layer adhered to the PP box will remain attached to the rim of the PP box. The adherence strength of EVA can be adjusted by changing the composition of the EVA material.

A further embodiment of the present invention will now be described with reference to FIG. 8D where there is shown a film 1H that may be formed to provide a bag with a first panel 80H and a second panel 81H.

The film may comprise of an exterior ply 210H made of PET, an adjacent ply 212H of nylon and an interior ply 211H of RCPP.

The release panel 3H preferably is of a two ply construction comprising of an exterior ply 90H of EVA and an interior ply 92H of PET.

This embodiment is similar to the embodiment of FIG. 8 except that (a) one PET layer and the PE/CPP layer have been replaced respectively by a nylon layer and a RCPP layer, (b) the Matt OPP layer of the release panel has been replaced by an EVA layer and as such no adhesive is required to be applied to the release panel for the purposes of avoiding a bonding between the ply 90H and the ply 211H of the panel 81H. The bag that may be defined by the embodiments shown in FIG. 8D does not require an adhesive to be applied to the release panel and no vacuum may be formed inside the bag. The bag may be particularly suitable for mixing tea bags with water.

The embodiment of FIG. 8D shows an optional zip lock 900. The zip lock may also herein be referred to an openable zip closure. The zip lock 900 may comprise of two complimentary strips 901 and 902. Strip 901 includes a female receptacle 903 and strip 902 includes a male receptacle 904 that can be releasable help in the female receptacle 903. The strips 901/902 may be bonded to the interior ply 211H in a location to be able to connect to each other. The strips may be made from PP or PE. The openable zip closure 900 creates on openable separation between two compartments 920 and 921 of the bag that may be formed from the film. This is shown for example in FIG. 8E. The film may be formed into a bag by perimeter heat-sealing and the zip lock extends across the film in a location to define two compartments 920 and 921. The release panel 3H may be located near an edge of the bag and allow for vent openings at 940/941 to form through the perimeter heat seal upon sufficient internal pressure build in the bag. The bag may have different substances in each compartment. One compartment may contain water and the other compartment may contain tea. The zip lock is able to keep the two substances from mixing until a user initiated act occurs to open the compartments to each other. In the case of water and tea for example, a user may place the bag in a microwave oven and heat the water. The water will start to boil, thereby expanding its compartment. This expansion will cause the zip lock to pry apart and open. This then allows the tea and water to mix to create a hot tea drink. Compartment 921 may contain the water so that upon heating of the water the initial bag expansion is accommodated by an opening of the zip lock. Any continued heating and resulting increase of the internal pressure of the bag will result in venting of the pressure via the vent openings at the release panel at the periphery of the bag. The bag may include a base formation at edge 945 that may allow the bag to self stand. The can allow for the bag to be self standing in a microwave oven with the water in the lower compartment 921. Boiling of the water in increasing pressure in compartment 921 will result in the zip lock opening and causing the tea to drop from above in compartment 920 into the water. This will facilitate mixing of the tea with the hot water. An example of a self standing bag is shown in FIG. 8H.

The zip lock may extend in a direction parallel the direction of the release panel when in the form of a strip. In other forms the release panel strip may extend perpendicular to the zip lock strip.

The use of the zip lock is shown with reference to the film of FIG. 8D but it will be appreciated that it can be used in other film embodiments herein described.

A further embodiment of the present invention will now be described with reference to FIG. 8I where a film 1I is shown that may be formed into a bag to define two panels 801 and 811 as shown. The film 1I may comprise of an exterior ply 210I of OPP or PET and an interior ply 211I of PE. The release panel 3I may comprise of EVA. The bag may be formed and may not require the use of an adhesive applied to the release panel and may be of a kind where no vacuum is formed inside. This embodiment of FIG. 8I is similar to the embodiment of FIG. 5 except that the EVA vent tape does not require the use of an adhesive to ensure a release between the release tape 31 and the ply 211I of the panel 81I.

A further embodiment will now be described with reference to FIG. 8J.

In FIG. 8J there is shown a film 1J that may be formed into a bag to define two panels 80J and 81J. The film 1J may comprise of an exterior ply 210J that may be of PET. The PET layer can add resistance against stretching for the bag. An adjacent layer 212J may be of nylon. A further adjacent layer 213J may be of PE. PE can act like a cementitious material filling up holes and gaps that may be formed. An interior ply 211J may comprise of RCPP.RCPP is preferable compared to CPP because RCPP heat sealing temperature is higher. CPP can melt and can become sticky from around 130° C. which is close to the water boiling point of the water.

A release panel 3J may be provided that may be comprised of three plies, namely an exterior ply 90J of EVA and an interior ply 92J that may be of PET. An intermediate ply 91J may comprise of PE. The three layers of the release panel 3J are preferably bonded together by adhesive. The embodiment of FIG. 8J is similar to the embodiment of FIG. 6 except the Matt OPP layer of the release ply has been replaced by an EVA layer and as such does not require the application of an adhesive to the EVA layer for the purposes of ensuring a vent opening being established between the EVA layer 90J and the interior ply 211J of the panel 81J.

The use of MATT OPP adhesive is preferable because there can be a slower release of steams-gas. If using EVA a higher internal pressure is needed to open the vent, then if MATT OPP adhesive is used. Using EVA the vent will open in a popping manner. Whereas MATT OPP adhesive the vent opens in a prying or pealing manner.

The provision of nylon helps maintain the vacuum. It also helps provide a tough primary panel that is less likely to be ruptured by the content when the bag is under vacuum.

As well as allowing fluids to escape when the contents are being heated, in some situations, food contained in the bag or container may generate ripening gasses. The gasses are able to at least in part vent from the bag thereby expelling them from contact with the food and this may help increase the longevity of the food in an edible form.

In the examples shown in FIGS. 5-8 the release panel is bedded into the interior most ply of the primary panel. In other embodiments the release panel may be applied to the interior face of the interior ply of the primary panel.

It is also possible to have the release panel located along an edge of the bag. Most of the description above shows the release panel located to transvers to an edge of the bag or film at where the venting is to happen. But instead the release panel, in a strip configuration, may extend parallel and at the edge and create a larger vent.

It will be appreciated that the present invention may have, as one of its advantages, an ability to avoid exploding or unexpected rupturing of a bag when being heated in a microwave oven for example. The vent opening able to be created when the internal pressure in the bag increases, can provide for pressure relief.

### Abbreviations and Remarks

CPP=cast polypropylene (It is for example heat sealable at about 130 to 150 degrees celcius, largely depending on the thickness of the CPP material).
PET=polyethylene terephthalate (It is for example non-heat sealable, but can soften at about 200 degrees Celsius)
PE=polyethylene (It is for example heat sealable at low heat. It can act like a cementitious material because it melts at about 110 degrees Celsius)
OPP=oriented polypropylene (It is for example non-heat sealable, but can soften at about 160 degrees Celsius)
EVA=ethylene vinyl acetate (It is for example often used as an easy tearing open film for containers due to its stickiness rather than bonding feature)
RCPP=retortable cast polypropylene (It is for example heat sealable at about 160 to 200 degrees Celsius)
MATT OPP=polytrimethylene terephthalate (It is a matt form of OPP)
PP=polypropylene
Nylon (It is non-heat sealable. It can act as a good shield against escape of steam or gas from a container)

1. A multi ply plastic film to create a heat-sealed enclosure for food to be heated inside the enclosure save for a region of the heat-seal where a vent-opening can be established to allow gas and/or steam to escape the enclosure during heating of the food, the film comprising:
a primary panel to create the enclosure by heat sealing to itself or a separate panel or to a peripheral lip of a container,
a release panel applied to said primary panel to be located intermediate of and to prevent the primary panel being heat-sealed to the primary panel and the peripheral lip or the peripheral heat-sealed region for the vent-opening to thereat be established.

2. A film as claimed in claim 1 wherein the release panel is adhered at one face side of and to said primary panel.

3. A film as claimed in claim 1 or 2 wherein the film is provided as roll-stock having an elongate direction and said release panel is a strip running continuously in the elongate direction.

4. A film as claimed in anyone of claims 1 to 3 wherein the film is provided as roll-stock having an elongate direction and said primary panel is continuous of said film.

5. A film as claimed in anyone of claims 1 to 4 wherein the film is provided as roll-stock having an elongate direction and said primary panel is continuous of said film and said release panel is a strip running continuously in the elongate direction applied at a first face side of said primary panel.

6. A film as claimed in anyone of claims 1 to 5 wherein the release panel comprising a release ply or coating exposed as a first face side of the primary panel, that is not heat-sealable to the primary panel and/or the peripheral lip.

7. A film as claimed in claim 6 wherein the coating is an adhesive.

8. A film as claimed in claim 6 wherein the release ply is of a non heat-sealable material.

9. A film as claimed in claim 8 wherein the release ply is of a non heat-sealable material and no coating is applied.

10. A film as claimed in claim 8 or 9 wherein the non heat-sealable material is selected from one of:
a. EVA
b. OPP
c. CPP,
d. MATT OPP, any

11. A film as claimed in anyone of claims 1 to 5 wherein the release panel comprises of a ply of material selected from one of:
a. PET,
b. Nylon,
c. OPP,
d. CPP,
e. EVA,
f. RCPP,
g. PE
and a coating exposed as a first face side of the primary panel comprised of an adhesive.

12. A film as claimed in anyone of claims 1 to 5 wherein the release panel comprises only of a ply of material selected from one of:
a. PET,
b. Nylon,
c. OPP,
d. CPP,
and a coating exposed as a first face side of the primary panel comprised of an adhesive.

13. A film as claimed in anyone of claims 1 to 5 wherein the release panel comprises of a ply of MATT OPP presented at a first face side of the primary panel and coated with an adhesive.

14. A film as claimed in claim 13 wherein the release panel also comprises a ply of PET.

15. A film as claimed in claim 14 wherein intermediate of the ply of PET and of MATT OPP is a ply of PE.

16. A film as claimed in claim 11 wherein the adhesive is a food grade adhesive.

17. A film as claimed in claim 11 wherein the adhesive is SEIKADYNE.

18. A film as claimed in anyone of claims 1 to 17 wherein, where adhesive is used, the adhesive is presented as the exposed material of the release panel.

19. A film as claimed in claim 14 or 15 wherein the plies of the release panel are adhered together.

20. A film as claimed in anyone of claims 1 to 19 wherein the release panel and primary panel are adhered together.

21. A film as claimed in anyone of claims 1 to 20 wherein the primary panel comprises a plurality of plies.

22. A film as claimed in claim 21 wherein the primary panel comprises a plurality of plies that are each co-extensive each other.

23. A film as claimed in claim 21 wherein the primary panel comprises a plurality of plies that are each co-extensive each other, other than the ply at the first face side of the primary panel that is to be heat-sealed which has a region absent at where said release panel is bedded.

24. A film as claimed in anyone of claims 23 to 34 wherein the ply of the primary panel defining the first face of the primary panel is one selected from:
a. CPP,
b. EVA,
c. RCPP, and
d. PE.

25. A film as claimed in anyone of claims 23 to 25 wherein the ply of the primary panel defining a second face thereof, opposite the first face, is one selected from:
a. OPP, and
b. PET.

26. A film as claimed in anyone of claims 1 to 25 wherein the first face of said primary panel is heat-sealed onto itself at regions of the periphery of the enclosure formed by the film, save for where the release panel is provided.

27. A film as claimed in anyone of claims 1 to 26 wherein the first face of said primary panel is not heat-sealed onto itself at regions of the periphery of the enclosure formed by the film where the periphery is formed by folded regions of the film.

28. A film as claimed in anyone of claims 1 to 26 wherein the first face of said primary panel is heat-sealed to the peripheral lip of the container save for where the release panel is provided.

29. A film as claimed in anyone of claims 1 to 28 wherein intermediate of the plies defining the first face and opposite face of the said primary panel there may be additional plies selected from at least one of:
a. Nylon
b. PET, and
c. PE.

30. A film as claimed in anyone of claims 1 to 29 wherein the release panel is of a strip of between 5 mm and 70 mm wide.

31. A film as claimed in claim 1 formed into a bag to define the enclosure and where the first face side of the film is heat sealed onto itself at the periphery of the enclosure.

32. A film as claimed in claim 1 formed into a bag to define the enclosure and where the first face side of the film is heat sealed onto itself at the periphery of the enclosure and across the enclosure to divide the enclosure onto two compartments, save for a passage able to be formed between the two compartments by the provision of the release panel at the divide.

33. A bag formed by a film as claimed in claim 32 wherein the first compartment contains a liquid and the second compartment contains food to be heated including by being exposed to said liquid.

34. A bag as claimed in claim 33 wherein the release panel is adapted to create a passage between the two compartments.

35. A bag formed by or comprising a film as claimed in claim 1 wherein at at least one perimeter region of the bag at there the first face of the first panel is heat-sealed onto itself, said release panel is provided to allow a passage for fluid between the enclosure and the outside of the bag.

36. A bag as claimed in claim 35 wherein the adhesive applied to the release panel, where provided, results in a releasable sealing interface of the release panel with the first face of the primary panel.

37. A bag as claimed in claim 36 wherein the adhesive of the release panel, where provided, results in a releasable and resealable sealing interface of the release panel with the first face of the primary panel.

38. A bag as claimed in claim 36 wherein the bag comprises said film of claim 1 defining a first panel of said bag and a second panel heat-sealed to the first panel at its perimeter to define an enclosure the first panel presenting the release panel as a strip that extends across the bag and between two opposed sides of the bag, the two opposed sides heat sealed together save for at where said strip is provided.

39. A bag as claimed in claim 38 wherein a tear notch is provided at one or each said opposed sides of the bag at where the bag can be torn by a user.

40. A container comprising a body defining at least one containment region bounded upwardly thereof by a perimeter lip of the body, the film of claim 1 heat sealed to the perimeter lip to cover the containment region and wherein the release panel is positioned at the lip to prevent heat-sealing of the primary panel to the lip so that a passage is or can be formed between the containment region and the outside of the container for the passage of fluid(s).

41. A container as claimed in claim 40 wherein there is an intermediate lip expending between two separated regions of the perimeter lip that creates two separate compartments of said containment region and where said film is heat sealed along the intermediate lip and the release panel is located at a region of the intermediate lip to prevent the primary panel heat-sealing thereat to the intermediate lip.

42. A bag able to be heated for making a hot beverage comprising the film of claim 1 formed into a bag comprising a first compartment and a second compartment separated from each other by a heat seal across the film, the primary panel being peripherally bonding to itself there being region for a vent opening able to be established at the release panel that extends at least across the heat-seal between the first and second compartments to allow said vent opening to be established between the first and second compartments, wherein the first compartment contains water and the second compartment contains an ingredient to mix with said water to at least in part dissolve in said water.

43. A bag comprising the film of claim 1 formed into a bag by having been folded and peripherally heat sealed onto itself or with like heat seal compatible film to define an enclosure with a first compartment and a second compartment separated from each other by a heat seal across the bag bonding the primary panel of the film of claim 1 to itself or a like heat seal compatible film such that a vent opening is able to be established at the release panel that extends at least across the heat-seal provided between the first and second compartments between the first and second compartments.

44. A bag as claimed in claim 43 wherein the release panel extends across a peripheral heat seal of at least one of said first and second compartments.

45. A bag as claimed in claim 43 wherein the release panel extends across a peripheral heat seal of said first compartment only so that at least some content of said second compartment escapes the second compartment via the vent into the first compartment.

46. A bag as claimed in any one of claims 43 to 45 wherein the first compartment has a release panel at a peripheral heat seal region.

47. A bag as claimed in claim 43 wherein the first compartment contains water and the second compartment contains an ingredient to mix with said water to at least in part dissolve in said water.

48. A film as claimed in anyone of claims 1 to 32 wherein a zip lock male and female strip are carried by said primary panel.

49. A film as claimed in claim 48 wherein said zip lock male and female strip extend parallel the elongate direction of the release panel.

50. A film as claimed in claim 48 wherein said zip lock male and female strip extend transverse the elongate direction of the release panel.

51. A bag comprising
a. the film of claim 1 formed into a bag by having been folded and peripherally heat sealed onto itself or with like heat seal compatible film to define an enclosure,
b. a zip lock extending across the enclosure to divide the enclosure into a first compartment and a second compartment, the first and second compartments able to be separated by said zip lock yet able to be connected upon an opening of the zip lock.

52. A bag as claimed in claim 51 wherein the release panel extends across a part of the peripheral seal between at least one of said first and second compartments and the outside the bag such that a vent opening can be established thereat to allow content of said at least one of said first and second compartments to escape from said bag.

53. A bag as claimed in claim 51 wherein the release panel extends across a part of the peripheral seal between one of said first and second compartments and the outside the bag such that a vent opening can be established thereat to allow content of said first or second compartments to escape from said bag.

54. A bag as claimed in claim 51 wherein the release panel extends across a peripheral heat seal of at least one of said first and second compartments.

55. A bag as claimed in claim 51 wherein the release panel extends across a peripheral heat seal of said first compartment only so that at least some content of said second compartment escapes the second compartment via opening between the first and second compartments able to be created by said zip lock, into the first compartment.

56. A bag as claimed in any one of claims 51 to 55 wherein the first compartment has a release panel at a peripheral heat seal region.

57. A bag as claimed in claim 51 wherein the first compartment contains water and the second compartment contains an ingredient to mix with said water to at least in part dissolve in said water.

58. A bag as claimed in claim 51 wherein the second compartment contains water and the first compartment contains an ingredient to mix with said water to at least in part dissolve in said water.

59. A bag comprising
a front and back panel connected to each other to form an enclosure,
a zip lock extending across the enclosure dividing the enclosure into a first compartment and a second compartment, the first and second compartments able to be separated by said zip lock yet able to be connected upon an opening of the zip lock.

60. A bag of claim 59 wherein the film has been folded and peripherally heat sealed onto itself or with like heat seal compatible film to define an enclosure.

61. A bag as claimed in claim 60 wherein the release panel extends across a part of the peripheral seal between at least one of said first and second compartments and the outside of the bag such that a vent opening can be established thereat to allow content of said at least one of said first and second compartments to escape from said bag.

62. A bag as claimed in claim 60 wherein the release panel extends across a part of the peripheral seal between one of said first and second compartments and the outside the bag such that a vent opening can be established thereat to allow content of said first or second compartments to escape from said bag.

63. A bag as claimed in claim 60 wherein the release panel extends across a peripheral heat seal of at least one of said first and second compartments.

64. A bag as claimed in claim 60 wherein the release panel extends across a peripheral heat seal of said first compartment only so that at least some content of said second compartment escapes the second compartment via opening between the first and second compartments able to be created by said zip lock, into the first compartment.

65. A bag as claimed in any one of claim 59 wherein the first compartment has a release panel at a peripheral heat seal region.

66. A bag as claimed in claim 59 wherein the first compartment contains water and the second compartment contains an ingredient to mix with said water to at least in part dissolve in said water.

67. A bag as claimed in claim 59 wherein the second compartment contains water and the first compartment contains an ingredient to mix with said water to at least in part dissolve in said water.
